(19) United States
(12) Patent Application Publication
(10) Pub. No.: US 2026/0305727 A1
(43) Pub. Date: Oct. 8, 2026

(54) An Assembly Comprising a Portable Charging Device and an Aerosol Generating Device, and a Method of Controlling the Same

(71) Applicant: JT International SA, Geneva (CH)

(72) Inventors: Hajime Fujita, Geneva (CH); Stéphane Hedarchet, Geneva (CH)

(73) Assignee: JT International SA, Geneva (CH)

(21) Appl. No.: 19/482,086

(22) PCT Filed: Apr. 26, 2024
(86) PCT No.: PCT/EP2024/061554

§ 371 Date: Nov. 6, 2025

(30) Foreign Application Priority Data
May 31, 2023 (EP) 23176307.9

(51) Int. Cl. A24F 40/90; A24F 40/51; A24F 40/53; A24F 40/60; A24F 40/65; H02J 7/42; H02J 7/60; H02J 7/70; H02J 7/90

(52) U.S. Cl. CPC A24F 40/90; A24F 40/51; A24F 40/53; A24F 40/60; A24F 40/65; H02J 7/42; H02J 7/685; H02J 7/731; H02J 7/971

(57) ABSTRACT

An assembly is described. The assembly comprise a portable charging device and an aerosol generating device that is physically connected with the portable charging device. The aerosol generating device comprises a motion sensor for detecting motion of the aerosol generating device. The portable charging device comprises a controller configured to control an operation of the portable charging device based on the motion of the aerosol generating device detected by the motion sensor.

### TECHNICAL FIELD

The present disclosure relates generally to an assembly comprising a portable charging device, and an aerosol generating device for generating an aerosol for inhalation by a user. The aerosol generating device may include an energy storage device (e.g., a battery) which may be charged by the portable charging device or an external power source.

The present disclosure is particularly applicable to a portable (hand-held) aerosol generating device.

### TECHNICAL BACKGROUND

Devices which heat, rather than burn, an aerosol generating material to produce an aerosol for inhalation have become popular with consumers in recent years. A commonly available reduced-risk or modified-risk device is the heated material aerosol generating device, or so-called heat-not-burn device. Devices of this type generate an aerosol or vapour by heating an aerosol generating material to a temperature typically in the range 150 °C to 300 °C. This temperature range is quite low compared to an ordinary cigarette. Heating the aerosol generating material to a temperature within this range, without burning or combusting the aerosol generating material, generates a vapour which typically cools and condenses to form an aerosol for inhalation by a user of the device.

Such devices may use one of a number of different approaches to provide heat to the aerosol generating material. All approaches for heating the aerosol generating material require some sort of power source or energy storage device such as a battery. The battery of the device may often be capable of being charged by a portable charging device (or “pocket charger”) which may include its own rechargeable power source or energy storage device. The power source or energy storage device of the portable charging device may be capable of being charged by an external power source such as a universal serial bus (USB) charger, for example. The portable charging device may be used to house, transport and charge the aerosol generating device when the user is out and about. More particularly, the aerosol generating device may be housed in the portable charging device by inserting it into an opening or recess in the housing or body of the portable charging device. When so inserted, the aerosol generating device will normally be physically connected to the portable charging device so that the aerosol generating device and the portable charging device form a physically integrated assembly that can be carried by user on their person or in a bag, for example. The aerosol generating device may also be electrically connected to the portable charging device so that its energy storage device may be charged using the portable charging device if required. This may allow the user to use the aerosol generating device for extended periods.

The portable charging device may include a push button or other user-operable input device which allows the user to control the operation of the portable charging device e.g., to start, stop or monitor the charging process, or to check the battery level, for example. Such a known portable charging device may therefore offer limited options for providing user input. The user input may be limited to whether a push button of the portable charging device is pressed for a short period of time, an intermediate period of time, or a long period of time, for example.

### SUMMARY OF THE DISCLOSURE

According to a first aspect of the present disclosure, there is provided an assembly comprising a portable charging device, and an aerosol generating device that is physically connected with the portable charging device, wherein the aerosol generating device comprises a motion sensor for detecting motion of the aerosol generating device, and the portable charging device comprises a first controller configured to control an operation of the portable charging device based on the motion of the aerosol generating device detected by the motion sensor.

The aerosol generating device may be received or housed in an opening or recess in the portable charging device, for example. In particular, it is preferred that when the aerosol generating device and the portable charging device are physically connected they form a physically integrated assembly so that if the user moves the portable charging device, the aerosol generating device that is received or housed in the portable charging device will also be moved in a corresponding manner. Put another way, moving the portable charging device will result in corresponding movement of the aerosol generating device or the assembly as a whole.

The motion sensor may comprise an accelerometer, for example, which is configured to detect the motion of the aerosol generating device. Such motion may include tilting, lifting, shaking or tapping the aerosol generating device, as well as more complex movements or gestures, for example. As mentioned above, such motion might be a result of the user tilting, lifting or shaking the portable charging device with which the aerosol generating device is physically connected. Tapping the portable charging device one or more times may also be detected by the motion sensor of the aerosol generating device if such tapping motion is transferred to the aerosol generating device. Put another way, such tapping motion may be detected by the motion sensor of the aerosol generating device even if the user does not make actual physically contact with the aerosol generating device, but instead taps the housing of the portable charging device, provided that such tapping motion is transferred sufficiently to the aerosol generating device to be detected.

It will be understood that detecting motion of the aerosol generating device, and using that detected motion to control an operation of the portable charging device, increases the range of possible user inputs that may be used to control the portable charging device when the aerosol generating device is physically connected to it. This may avoid the need to adapt or modify the portable charging device so that it can accept additional user inputs, e.g., by providing the portable charging device with additional push buttons or other user-operable input devices. This allows the portable charging device to maintain a simplified construction. Additional user inputs may be most useful when the portable charging device is being used to charge the aerosol generating device. This is also when the aerosol generating device is physically and electrically connected to the portable charging device so that the detected motion of the aerosol generating device can be used as user inputs for controlling an operation of the portable charging device.

The aerosol generating device may further comprise a second controller that is electrically connected to the motion sensor. The first and second controllers may include one or more microprocessor units (MPUs) or microcontroller units (MCU), for example. The second controller may be electrically connected to the first controller when the aerosol generating device is physically connected with the portable charging device. More particularly, an electrical connection between the aerosol generating device and the portable charging device may be used to charge the power source or energy storage device of the aerosol generating device and also to provide data communication between the first and second controllers. More particularly, the electrical connection may be provided by one or more terminals on the portable charging device and one or more corresponding terminals on the aerosol generating device. The terminals are adapted to be electrically connected when the aerosol generating device is properly received in the portable charging device. The terminals may be used to provide one or more links between electrical circuits of the portable charging and aerosol generating devices. For example, the links may includes a data communication link and a charging link. There may also be detection link that is used to detect if an electrical connection between the portable charging device and the aerosol generating device has been made, and a ground link that provides a common ground connection for the components of the electrical circuits, for example. The second controller may be configured to transmit motion data to the first controller, i.e., to transmit data that is indicative of the motion detected by the motion sensor. In this way, motion detected by the motion sensor of the aerosol generating device may be conveniently transmitted to the first controller of the portable charging device, where it may be used to control an operation of the portable charging device.

The second controller may be further configured to convert the motion data from the motion sensor so that the volume of the transmitted motion data is reduced. For example, the motion data that the second controller receives from the motion sensor may be simplified or processed by the second controller. The second controller may be further configured to transmit the converted (i.e., simplified or processed motion data) to the first controller. This reduces the volume of motion data that needs to be transmitted from the aerosol generating device to the portable charging device, e.g., through a data communication link.

The second controller may also be further configured to determine if the motion data from the motion sensor meets a predefined criterion, and then convert the motion data into simplified motion data indicating whether the motion data meets the predefined criterion. Each predefined criterion may correspond to a different user input, e.g., to a different motion of the aerosol generating device that might be used to control the portable charging device in a different way. For example, the second controller may be configured to determine if the motion data from the motion sensor indicates that the aerosol generating device has been shaken and then to transmit to the first controller simplified motion data that indicates that the aerosol generating device has been shaken. The first controller may use the simplified motion data to control an operation of the portable charging device. This reduces the volume of motion data that needs to be transmitted from the aerosol generating device to the portable charging device and reduces the processing that needs to be carried out by the first controller of the portable charging device. The second controller may already be adapted to process motion data—i.e., if the motion sensor is also used to detect user inputs for controlling the operation of the aerosol generating device such as start heating, stop heating, boost heating etc. while the aerosol generating device is being used. In this case, it may be more appropriate to use simplified motion data because it avoids the need for the first controller to also be adapted to process the motion data.

The converted motion data may be transmitted from the second controller to the first controller along a single electrical wire (or through a single data communication link). The portable charging device may comprise a single data communication terminal that is electrically connected to the first controller and the aerosol generating device may comprise a single data communication terminal that is electrically connected to the second controller. When the aerosol generating device is physically connected to the portable charging device, the respective data communication terminals are electrically connected and provide a single data communication link between the first and second controllers.

The second controller may be further configured to disable the motion sensor when the aerosol generating device enters a sleeping (or “standby”) mode. The second controller may be further configured to detect an electrical connection between the portable charging device and the aerosol generating device, and enable the motion sensor when the electrical connection between the portable charging device and the aerosol generating device is detected. This may extend battery life by disabling the motion sensor when motion data is not needed, and enabling it when the aerosol generating device is electrically connected to the portable charging device—i.e., when motion data from the motion sensor might be used to control an operation of the portable charging device.

The second controller may be further configured to control an operation of the aerosol generating device based on the motion of the aerosol generating device detected by the motion sensor. The detected motion may be used to control the aerosol generating device when it is physically connected to the portable charging device or when it is not physically connected to the portable charging device—e.g., when it is being used to generate an aerosol.

When the aerosol generating device is received or housed in the portable charging device, the first controller may be further configured to control an operation of the portable charging device based on the motion of the aerosol generating device detected by the motion sensor except for tapping (e.g., where the detected motion is lifting, tilting or shaking, but not tapping) and the second controller may be further configured to control an operation of the aerosol generating device based on the user tapping the aerosol generating device detected by the motion sensor. This may allow the aerosol generating device and the portable charging device to be controlled separately based on different motions detected by the motion sensor.

The portable charging device may further comprise a user interface system comprising a plurality of predefined user inputs, and at least one predefined essential operating function of the portable charging device. At least one of the predefined user inputs may be based on the motion of the aerosol generating device detected by the motions sensor, i.e., using the received motion data. The term “user input” means any input that may be provided by the user of the portable charging device, e.g., for operating or controlling an operation of the portable charging device. Each user input may correspond to a particular action that is performed by the user. For example, if the user presses a push button of the portable charging device for a certain period of time, this may correspond to a certain user input of the user interface system. A non-exhaustive list of possible user inputs may include pressing a push button of the portable charging device for a short, intermediate, or long period of time (e.g., “short press”, “intermediate press” or “long press”), or interacting with some other type of user input device, or lifting, tilting, shaking or tapping (e.g., “move device”, “shake device”, “tap once”, “tap twice” etc.) detected by the motion sensor when the aerosol generating device is physically connected to the portable charging device.

A plurality of user inputs is defined as part of the user interface system and may be selectively enabled or disabled by the user. The one or more predefined user inputs may be stored, e.g., in a memory.

The term “essential operating function” means any operating function that is essential to the operation of the portable charging device such as starting, stopping or monitoring charging of the power source or energy storage device of the aerosol generating device (e.g., “monitor charging process”), for example.

One or more essential operating functions are predefined as part of the user interface system. The one or more predefined essential operating functions may be stored, e.g., in a memory.

The user interface system may be selectively configurable by a user to disable and enable at least one of the user inputs, and assign one or more of the enabled user inputs to each essential operating function of the portable charging device, i.e., so that the user interface system is configured to control the portable charging device to carry out a particular operating function in response to any of the one or more assigned user inputs. The user interface system may notify the user if an essential operating function does not have at least one user input assigned to it. Operation of the portable charging device may be stopped until at least one user input is assigned to each essential operating function, or such assignment may be made by the user interface system to make sure that the portable charging device can be controlled properly.

The user interface system may further comprise at least one predefined non-essential operating function of the portable charging device. The user interface system may be further selectively configurable by the user to disable and enable at least one of the non-essential operating functions, and assign one or more of the enabled user inputs to each enabled non-essential operating function of the portable charging device. This allows the user more flexibility in controlling the portable charging device because the user may configure the user interface system to use their preferred user inputs to carry out the particular essential and non-essential operating functions of the portable charging device. The term “non-essential operating function” means any operating function that is not essential to the operation of the portable charging device such as checking the battery level of the portable charging device and/or the aerosol generating device (or “check battery level”), or rebooting the portable charging device (or “reboot device”), for example. Such non-essential operating functions may help the user to interact with, or control the operation of, the portable charging device.

One or more non-essential operating functions are predefined as part of the user interface system. The one or more predefined non-essential operating functions may be stored, e.g., in a memory. The user interface system may comprise a user interface that is responsive to the enabled user inputs and which initiates the particular essential or non-essential operating function of the portable charging device, e.g., where the user interface outputs a control signal.

The one or more enabled user inputs may be selectively assigned to each enabled operating function of the aerosol generating device by the user using a software application, e.g., a mobile application (or “mobile app”). A portable electronic device such as a smartphone or tablet running the software application may communicate with the portable charging device using any suitable communication protocol (e.g., Bluetooth®) or over a wireless network. Data exchanged between the electronic device and the portable charging device may be used to update the user interface system so that changes corresponding to those made by the user using the software application are also made to the user interface system operating on the portable charging device. The portable charging device may comprise any suitable communication device such as a transceiver and a digital controller for providing wireless communication with the electronic device. Data exchanged between the electronic device and the portable charging device may be used to update the user interface system. The electronic device may also be connected to the portable charging device, e.g., using a USB cable.

The user interface system may notify the user if any of the enabled user inputs are not assigned to one or more enabled operating functions. Any enabled user inputs that are not assigned may be disabled by the user interface system. The user may notify the user if an enabled non-essential operating function does not have at least one user input assigned to it. Any enabled non-essential operating function that does not have at least one user input assigned to it may be disabled by the user interface system.

The user interface system may be further selectively configurable by the user to assign any of the enabled user inputs to two or more compatible enabled operating functions. In this case, it will be readily understood that the term “enabled operating functions” includes any enabled non-essential operating functions and the essential operating functions, which cannot be disabled. For example, it may be possible to assign one of the input functions to control multiple enabled operating functions. However, the user interface system may be further configured to prevent any of the enabled user inputs from being assigned by the user to two or more non-compatible enabled operating functions. Combinations of non-compatible enabled operating functions may be stored, e.g., in a memory.

The portable charging device may further comprise an output device, e.g., one or more LEDs that are driven by a LED driver. The first controller may be configured to control an operation of the output device based on the motion of the aerosol generating device detected by the motion sensor.

The aerosol generating device may be a holder for receiving an aerosol generating article (or consumable) and is configured to generate an aerosol for inhalation by a user, optionally by heating aerosol generating material. The aerosol generating article may be inserted into an aerosol generating space or heating chamber of the aerosol generating device. The aerosol generating article may comprise the aerosol generating material.

The aerosol generating device is typically a hand-held, portable, device.

The aerosol generating device may be configured to heat the aerosol generating material or substrate, without burning the aerosol generating material, to volatise at least one component of the aerosol generating material and thereby generate a heated vapour which cools and condenses to form an aerosol for inhalation by a user of the aerosol generating device during a vaping session. The aerosol generating device may generate an aerosol in other ways, e.g., by using an ultrasonic transducer to atomise a liquid aerosol forming substrate.

In general terms, a vapour is a substance in the gas phase at a temperature lower than its critical temperature, which means that the vapour may be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The aerosol generating device may comprise a heating chamber for receiving at least part of an aerosol generating material, and a heater configured to heat the aerosol generating material to generate an aerosol. The heater may be a low power thin film heater, printed heater etc. An induction heater may be preferred. An induction heater may comprise an induction coil and a susceptor and may be configured to heat the aerosol generating material. For example, the induction coil may be positioned adjacent an aerosol generating space or heating chamber of the aerosol generating device that is designed to receive the aerosol generating material, where the aerosol generating material is optionally part of an aerosol generating article or consumable that is received in the aerosol generating device in use. When the induction heater is used to heat the aerosol generating material, an alternating electromagnetic field is generated by the induction coil. A susceptor may be associated with the aerosol generating material, e.g., positioned adjacent to or embedded in the aerosol generating material, and may be part of the aerosol generating article or the aerosol generating device. The susceptor couples with the electromagnetic field and generates heat due to eddy currents and/or magnetic hysteresis, which heat is then transferred from the susceptor to the aerosol generating material. To generate the alternating electromagnetic field necessary for induction heating, the aerosol generating device may further comprise an inverter that is electrically connected to the induction coil.

The aerosol generating material may comprise any type of solid or semi-solid material. Example types of aerosol generating solids include powder, granules, pellets, shreds, strands, particles, gel, strips, loose leaves, cut filler, porous material, foam material or sheets. The aerosol generating material may comprise plant derived material and in particular, may comprise tobacco. It may advantageously comprise reconstituted tobacco, for example including tobacco and any one or more of cellulose fibres, tobacco stalk fibres and inorganic fillers such as calcium carbonate (CaCO₃).

Consequently, the aerosol generating device may be referred to as a “heated tobacco device”, a “heat-not-burn tobacco device”, a “device for vaporising tobacco products”, and the like, with this being interpreted as a device suitable for achieving these effects.

The features disclosed herein are equally applicable to devices which are designed to vaporise any aerosol generating material, including a liquid material or substrate.

As mentioned briefly above, the aerosol generating material may form part of an aerosol generating article that is received in the aerosol generating device, for example by inserting the aerosol generating article into an aerosol generating space or heating chamber of the aerosol generating device. The aerosol generating article may include a filter segment, for example comprising cellulose acetate fibres, at a proximal end of the aerosol generating article. The filter segment may constitute a mouthpiece filter and may be in coaxial alignment with the aerosol generating material. One or more vapour collection regions, cooling regions, and other structures may also be included in some designs. For example, the aerosol generating article may include at least one tubular segment upstream of the filter segment. The tubular segment may act as a vapour cooling region. The vapour cooling region may advantageously allow the heated vapour generated by heating the aerosol generating material to cool and condense to form an aerosol with suitable characteristics for inhalation by a user, for example through the filter segment.

The aerosol generating material may comprise an aerosol-former. Examples of aerosol-formers include polyhydric alcohols and mixtures thereof such as glycerine or propylene glycol. Typically, the aerosol generating material may comprise an aerosol-former content of between approximately 5% and approximately 50% on a dry weight basis. In some embodiments, the aerosol generating material may comprise an aerosol-former content of between approximately 10% and approximately 20% on a dry weight basis, and possibly approximately 15% on a dry weight basis.

Upon being heated, the aerosol generating material may release volatile compounds. The volatile compounds may include nicotine or flavour compounds such as tobacco flavouring.

The aerosol generating material may be a liquid material or substrate and the device may comprise an atomising arrangement to atomise the liquid material or substrate, including without heating. The liquid material or substrate may also be heated.

According to a second aspect of the present disclosure, there is provided a software application for selectively configuring the user interface system of the portable charging device as described above. The software application may be a mobile application (or “mobile app”) developed specifically for use on small portable electronic devices such as smartphones or tablets. The user inputs, operating functions etc., and the relationship between them, are represented graphically on the portable electronic device. For example, they may be represented as buttons with lines between the buttons to indicate an assigned relationship. The user inputs and operating functions of the user interface system may be disabled or enabled or related or assigned by touching the corresponding graphical representation, or by other direct manipulation of the graphical representations using the touchscreen of the electronic device, for example.

According to a third aspect of the present disclosure, there is provided a method of controlling an assembly comprising a portable charging device, and an aerosol generating device that is physically connected with the portable charging device, the method comprising controlling an operation of the portable charging device based on detected motion of the aerosol generating device.

Further details of the portable charging device and aerosol generating device may be described above.

### BRIEF DESCRIPTION OF THE DRAWINGS

FIG. 1 is a diagrammatic view of an example of an aerosol generating system comprising an aerosol generating device and an aerosol generating article;

FIG. 2 is a schematic representation of an example of a portable charging device;

FIG. 3 is a schematic representation of an example of an assembly where the aerosol generating device of FIG. 1 is physically connected to the portable charging device of FIG. 2;

FIG. 4 is a schematic representation of an example of electrical circuits of the aerosol charging device and the portable charging device; and

FIG. 5 is a schematic representation of an example of a selectively configurable user interface system of the portable charging device of FIGS. 2 and 3.

### DETAILED DESCRIPTION OF EMBODIMENTS

Embodiments of the present disclosure will now be described by way of example only and with reference to the accompanying drawings.

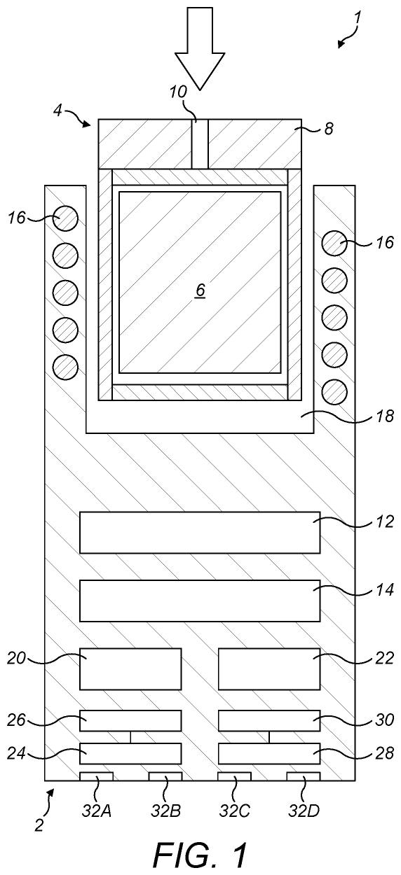

Referring initially to FIG. 1, there is shown diagrammatically an example of an aerosol generating system 1 including an aerosol generating device 2 (or “holder”) and an aerosol generating article 4.

The aerosol generating article 4 may be generally cylindrical and include aerosol generating material 6. At the proximal end, the aerosol generating article 4 includes a mouthpiece 8 having an outlet 10 through which a user may inhale an aerosol that is generated by heating the aerosol generating material 6.

The aerosol generating device 2 includes a first electrical circuit 12 and a first energy storage device 14 such as a battery (e.g., a lithium-ion secondary battery).

The aerosol generating device 2 may optionally include one or more heaters or other aerosol generators. The aerosol generating device 2 shown in FIG. 1 includes an induction heater with an induction coil 16 that is arranged adjacent an aerosol generating space or heating chamber 18 for heating the aerosol generating material 6 when the aerosol generating article 4 is inserted in the aerosol generating device 2. The aerosol generating article 4 or the aerosol generating device 2 may include one or more susceptors (not shown) that couple with the electromagnetic field and generate heat due to eddy currents and/or magnetic hysteresis, which heat is then transferred from the susceptor to the aerosol generating material 6. It will be readily understood that other aerosol generators may be used, including those that are configured to generate an aerosol without heating, e.g., by using an ultrasonic transducer to atomise a liquid aerosol forming substrate. A resistive heater may be employed in addition to or instead of the induction heater.

The aerosol generating device 2 includes an accelerometer 20, a first push button 22, one or more first LEDs 24 that are electrically connected to a first LED driver 26, and a haptic actuator 28 (e.g., an eccentric rotating mass vibration motor) that is electrically connected to a motor driver 30. At least one of the accelerometer 20, the first push button 22, the first LEDs 24, the first LED driver 26, the haptic actuator 28, and the motor driver 30 may form part of the first electrical circuit 12. The first LED driver 26 and/or the motor driver 30 may be omitted if the first electrical circuit 12 is configured to directly control the first LEDs 24 and/or the haptic actuator 28.

The aerosol generating device 2 also includes four electrical terminals, namely:
a first data communication terminal 32A,
a first charging terminal 32B,
a first detection terminal 32C, and
a first ground terminal 32D.

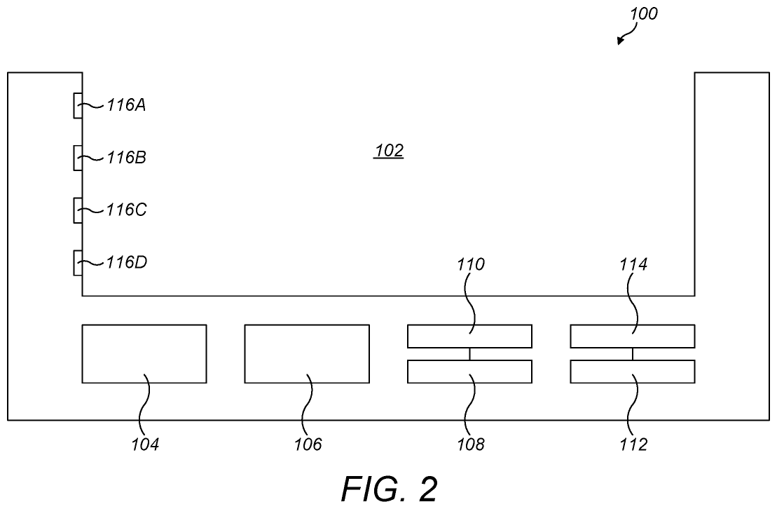

Referring to FIG. 2, there is shown diagrammatically an example of portable charging device 100 (or “pocket charger”).

The portable charging device 100 includes a recess 102 that is shaped and sized to house or receive the aerosol generating device 2. The user may therefore utilise the portable charging device 100 to conveniently house and transport the aerosol generating device 2 when it is not being used for vaping. The portable charging device 100 may also be used to charge the first energy storage device 14 of the aerosol generating device 2. The portable charging device 100 includes a second electrical circuit 104 and a second energy storage device 106 such as a battery (e.g., a lithium-ion secondary battery). The portable charging device 100 also includes a second push button 108 electrically connected to a push button controller 110 and one or more second LEDs 112 that are electrically connected to a second LED driver 114. At least one of the second push button 108, the push button controller 110, the second LEDs 112, and the second LED driver 114 may form part of the second electrical circuit 104. The second LED driver 114 may be omitted if the second electrical circuit 104 is configured to directly control the second LEDs 24.

The portable charging device 100 also includes four electrical terminals, namely,
a second data communication terminal 116A,
a second charging terminal 116B,
a second detection terminal 116C, and
a second ground terminal 116D.

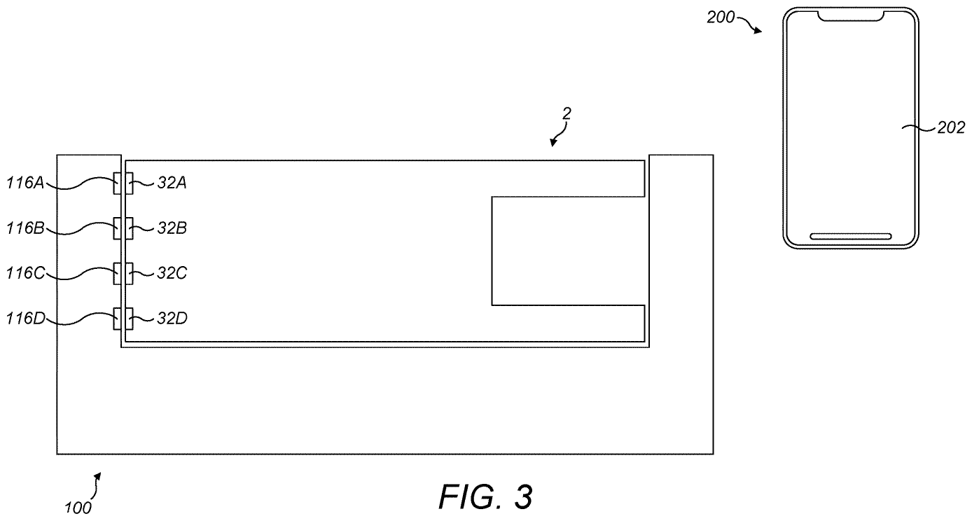

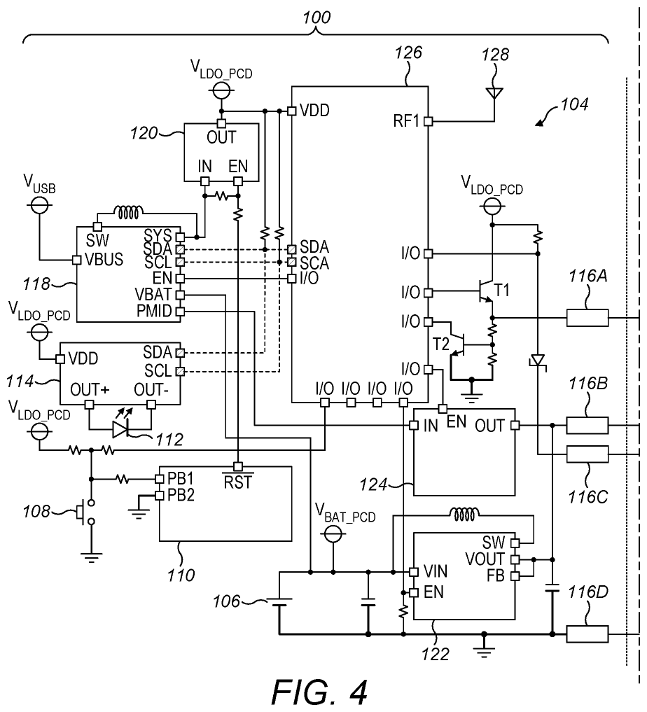

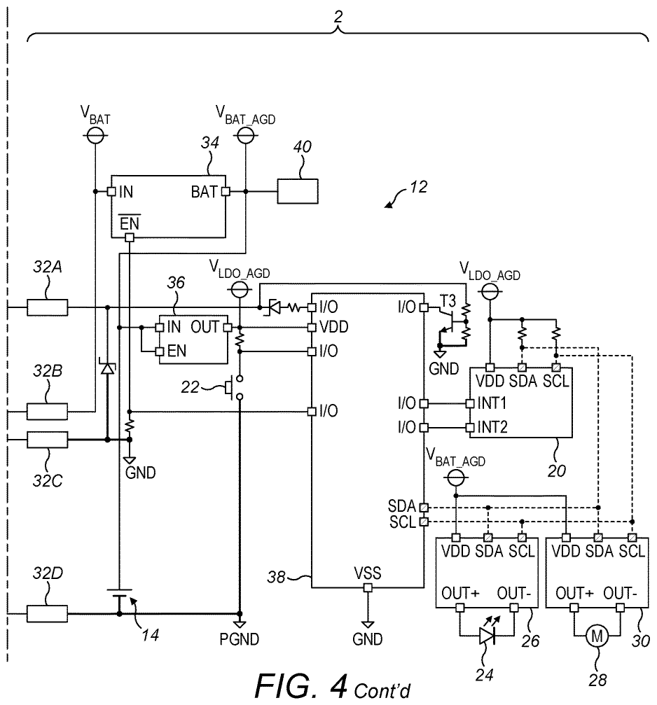

When the aerosol generating device 2 is received or housed in the recess 102 of the portable charging device 100, to form a physically integrated assembly shown in FIG. 3, the electrical terminals 32A, 32B, . . . , 32D are respectively electrically connected to the electrical terminals 116A, 116B, . . . , 116D to provide an electrical connection between the aerosol generating device 2 and the portable charging device 100. This electrical connection between the first electrical circuit 12 and the second electrical circuit 104 is shown in more detail in FIG. 4.

The electrical circuit 12 of the aerosol generating device 2 includes:
a first charging circuit 34,
a first low-dropout (LDO) regulator 36, and
a first microcontroller unit (MCU) 38.

The first charging circuit 34, first LDO regulator 36, and first MCU 38 may be implemented as integrated circuits.

The second electrical circuit 104 of the portable charging unit 100 includes:
a second charging circuit 118,
a second LDO regulator 120,
a DC/DC converter 122,
a switching circuit 124, and
a second MCU 126.

The second charging circuit 118, second LDO regulator 120, DC/DC converter 122, switching circuit 124, and second MCU 126 may be implemented as integrated circuits.

The second charging circuit 118 includes:
an input terminal (labelled “VBUS”) electrically connectable to an external power source such as a universal serial bus (USB) charger (not shown),
a battery terminal (labelled “VBAT”) electrically connected to the positive terminal of the second energy storage device 106 of the portable charging device 100, i.e., the lithium-ion secondary battery,
a voltage output terminal (labelled “PMID”),
a system terminal (labelled “SYS”),
a switching node terminal (labelled “SW”) electrically connected to the system terminal by means of an inductor,
a serial data terminal (labelled “SDA”) and a serial clock terminal (labelled “SCL”) that are electrically connected to corresponding terminals of the second MCU 126, and
an enable terminal (labelled “EN”) electrically connected to a first input/output terminal (labelled “I/O”) of the second MCU 126 and which allows the second MCU 126 to enable charging of the second energy storage device 106 (or the first energy storage device 14—see details below) from the external power source. More particularly, the second MCU 126 sends an enable signal from the first input/output terminal to the enable terminal when the energy storage device is to be charged.

The second charging circuit 118 may be used to charge the second energy storage device 106 from the external power source and to provide an output voltage at the system terminal. The second charging circuit 118 may also be used to charge the first energy storage device 14 from the external power source by providing an output voltage from the voltage output terminal to the first charging circuit 34 though the switching circuit 124, when enabled, and the first and second charging terminals 32B, 116B.

The second LDO regulator 120 includes:
an input terminal (labelled “IN”) electrically connected to the system terminal of the second charging circuit 118,
an output terminal (labelled “OUT”) that provides a regulated voltage supply, and
an enable terminal (labelled “EN”) electrically connected to the system terminal of the second charging circuit 118.

In this embodiment, the enable terminal of the second LDO regulator 120 works according to positive logic and the input and enable terminals of the second LDO regulator are electrically connected to the system terminal of the second charging circuit 118 in parallel. This means that the second LDO regulator 120 continuously outputs a regulated voltage from the output terminal unless the system voltage is unavailable. The enable terminals of the second charging circuit 118, DC/DC converter 122, and switching circuit 124 may use positive or negative logic.

The DC/DC converter 122 typically operates as a boost (or step-up) converter and converts a DC input voltage into a suitable boosted DC output voltage. The DC/DC converter 122 includes:
a voltage input terminal (labelled “VIN”) electrically connected to the positive terminal of the second energy storage device 106,
a switching node terminal (labelled “SW”) electrically connected to the voltage input terminal by means of an inductor,
a voltage output terminal (labelled “VOUT”) electrically connected to the second charging terminal 116B,
a feedback terminal (labelled “FB”) electrically connected to the voltage output terminal, and
an enable terminal (labelled “EN”) electrically connected to a second input/output terminal (labelled “I/O”) of the second MCU 126 and which allows the second MCU 126 to enable and disable operation of the DC/DC converter 122. More particularly, the second MCU 126 sends an enable or disable signal from the second input/output terminal to the enable terminal depending on whether the DC/DC converter 122 is to be operated or not.

The switching circuit 124 includes:
an input terminal (labelled “IN”) electrically connected to the voltage output terminal of the second charging circuit 118,
an output terminal (labelled “OUT”) electrically connected to the second charging terminal 116B in parallel with the voltage output terminal of the DC/DC converter 112, and
an enable terminal (labelled “EN”) electrically connected to a third input/output terminal (labelled “I/O”) of the second MCU 126 and which allows the second MCU 126 to control the switching operation of the switching circuit 124. More particularly, the MCU 126 sends an enable or disable signal from the third input/output terminal to the enable terminal to switch the switching circuit 124 on and off.

When the switching circuit 124 is enabled by the second MCU 126, the voltage output terminal of the second charging circuit 118 is electrically connected with the second charging terminal 116B so that power from the external power source such as a USB charger (not shown) may be supplied to the first charging circuit 34. The first energy storage device 14 may therefore be charged by the second energy storage device 106 or external power source. In the first case, the first energy storage device 14 is charged from the second energy storage device 16 by enabling the DC/DC converter 122 to supply the boosted DC output voltage to the enabled first charging circuit 34. In the second case, the first energy storage device 14 is charged from the external power source that is electrically connected to the input terminal of the second charging circuit 118 by enabling the second charging circuit 118, the switching circuit 124, and the second charging circuit 34. The switching circuit 124 is therefore functioning as a power distribution switching circuit.

The second MCU 126 includes a power supply terminal (labelled “VDD”) electrically connected to the output terminal of the second LDO regulator 120 and receives a regulated voltage supply. As noted above, the second MCU 126 includes a serial data terminal (labelled “SDA”) and a serial clock terminal (labelled “SCL”) that are electrically connected to corresponding terminals of the second charging circuit 118 and the second LED driver 114. The second MCU 126 also includes:
first, second, and third input/output terminals (labelled “I/O”) that are respectively to the enable terminals of the second charging circuit 118, DC/DC converter 122, and switching circuit 124,
a fourth input/output terminal (labelled “I/O”) electrically connected to the output terminal of the second LDO regulator 120 by a pair of series-connected resistors, the second push button 108 being electrically connected to the junction point between the pair of resistors,
fifth and sixth input/output terminals (labelled “I/O”) electrically connected to the second data communication terminal 116A by means of a pair of semiconductor switches T1 and T2 as described in more detail below,
a seventh input/output terminal (labelled “I/O”) electrically connected to the detection terminal 116C by means of a Zener diode, and to the output terminal of the second LDO regulator 120 by means of a resistor-more particularly, where the seventh input/output terminal is electrically connected to a junction point between the resistor and the Zener diode, and
an eighth input/output terminal (labelled “RF1”) electrically connected to an antenna 128.

The fifth input/output terminal of the second MCU 126 is electrically connected to the base terminal of a first semiconductor switch T1 (e.g., a first transistor). The collector terminal of the first semiconductor switch T1 is electrically connected to the output terminal of the second LDO regulator 120. The emitter terminal of the first semiconductor switch T1 is electrically connected to the second data communication terminal 116A.

The sixth input/output terminal is electrically connected to the collector of a second semiconductor switch T2 (e.g., a second transistor). The emitter terminal of the second semiconductor switch T2 is electrically connected to a ground connection. The base terminal of the second semiconductor switch T2 is electrically connected to the same ground connection by means of a first resistor, and to the second data communication terminal 116A of the portable charging device 100 by means of a second resistor. More particularly, the second data communication terminal 116A is electrically connected to the junction point between the second resistor and the emitter terminal of the first semiconductor switch T1.

The push button controller 110 includes:
a first push button input terminal (labelled “PB1”) electrically connected to the second push button 108,
a second push button input terminal (labelled “PB2”) electrically connected to ground, and
a reset terminal (labelled “RST”) electrically connected to the system terminal of the second charging circuit 118 so it receives the system voltage.

The second LED driver 114 includes:
a power supply terminal (labelled “VDD”) electrically connected to the output terminal of the second LDO regulator 120,
a serial data terminal (labelled “SDA”) and a serial clock terminal (labelled “SCL”) that are electrically connected to corresponding terminals of the second MCU 126, and
positive and negative voltage output terminals (labelled “OUT+” and “OUT−”) electrically connected to the one or more second LEDs 112.

The first charging circuit 34 includes:
an input terminal (labelled “IN”) electrically connected to the first charging terminal 32B,
a battery terminal (labelled “BAT”) electrically connected to the positive terminal of the first energy storage device 14, i.e., the lithium-ion secondary battery, and
an enable terminal (labelled “EN”) electrically connected to a first input/output terminal (labelled “I/O”) of the first MCU 38 and which allows the first MCU 38 to enable charging of the first energy storage device 14 from the second energy storage device 106 of the portable charging device 100 or the external power source through the switching circuit 124. More particularly, the first MCU 38 sends an enable signal from the first input/output terminal when the first energy storage device 14 is to be charged.

The first input/output terminal of the first MCU 38 and the enable terminal of the first charging circuit 34 are also electrically connected to a ground connection by means of a resistor. More particularly, the first input/output terminal of the first MCU 38 is electrically connected to a junction point between the enable terminal of the first charging circuit 34 and the resistor.

An induction heater 40 is electrically connected to the first energy storage device 14. A different aerosol generator may also be used, including an aerosol generator that is configured to generate an aerosol without heating, e.g., using an ultrasonic transducer to atomise a liquid aerosol forming substrate.

The first LDO regulator 36 includes:
an input terminal (labelled “IN”) electrically connected to the positive terminal of the first energy storage device 14,
an output terminal (labelled “OUT”) that provides a regulated voltage supply, and
an enable terminal (labelled “EN”) electrically connected to the first energy storage device 14.

In this embodiment, the enable terminal of the first LDO regulator 36 works according to positive logic and the input and enable terminals of the first LDO regulator 36 are electrically connected to the first energy storage device 14 in parallel. This means that the first LDO regulator 36 continuously outputs a regulated voltage from the output terminal unless the input voltage from the first energy storage device 14 is unavailable.

The accelerometer 20 includes:
a power supply terminal (labelled “VDD”) electrically connected to the output terminal of the first LDO regulator 36 and receives a regulated voltage supply,
a first inertial interrupt terminal (labelled “INT1”),
a second inertial interrupt terminal (labelled “INT2”), and
a serial data terminal (labelled “SDA”) and a serial clock terminal (labelled “SCL”) that are electrically connected to corresponding terminals of the first MCU 38.

The first push button 22 is electrically connected to a power ground connection (labelled “PGND”) and to the output terminal of the first LDO regulator 36 by means of a resistor. The power ground connection is electrically connected to the first ground terminal 32D. The negative terminal of the first energy storage device 14 is also electrically connected to the power ground connection.

The first LED driver 26 includes:
a power supply terminal (labelled “VDD”) electrically connected to the first energy storage device 14,
a serial data terminal (labelled “SDA”) and a serial clock terminal (labelled “SCL”) that are electrically connected to corresponding terminals of the first MCU 38, and
positive and negative voltage output terminals (labelled “OUT+” and “OUT−”) electrically connected to the one or more first LEDs 24.

The motor driver 30 includes:
a power supply terminal (labelled “VDD”) electrically connected to the first energy storage device 14,
a serial data terminal (labelled “SDA”) and a serial clock terminal (labelled “SCL”) that are electrically connected to corresponding terminals of the first MCU 38, and
positive and negative voltage output terminals (labelled “OUT+” and “OUT−”) electrically connected to the haptic actuator 28.

The first MCU 38 includes a power supply terminal (labelled “VDD”) electrically connected to the output terminal of the first LDO regulator 36 and receives a regulated voltage supply. As noted above, the MCU 38 includes a serial data terminal (labelled “SDA”) and a serial clock terminal (labelled “SCL”) that are electrically connected to corresponding terminals of the accelerometer 20, the first LED driver 26, and the motor driver 30.

The first MCU 38 also includes:
a first input/output terminal (labelled “I/O”) electrically connected to the enable terminal of the first charging circuit 34, and to a ground connection labelled “GND” by means of a resistor,
second and third input/output terminals (labelled “I/O”) respectively electrically connected to the inertial interrupt terminals of the accelerometer 20,
a fourth input/output terminal (labelled “I/O”) electrically connected to the junction point between push button 22 and the resistor that electrically connects the push button 22 to the output terminal of the first LDO regulator 36,
fifth and sixth input/output terminals (labelled “I/O”) electrically connected to the first data communication terminal 32A as described in more detail below, and
a power terminal (labelled “VSS”) electrically connected to the ground connection labelled “GND”.

The fifth input/output terminal of the first MCU 38 is electrically connected to the collector terminal of a third semiconductor switch T3 (e.g., a third transistor). The emitter of the third semiconductor switch T3 is electrically connected to the ground connection labelled “GND”. The base terminal of the third semiconductor switch T3 is electrically connected to the first data communication terminal 32A by means of a first resistor, and to the same ground connection by means of a second resistor. The sixth input/output terminal is electrically connected to the first data communication terminal 32A by means of a resistor and Zener diode. The base terminal of the third semiconductor switch T3 is electrically connected to a junction point between the Zener diode and the first data communication terminal 32A, i.e., on the terminal-side of the Zener diode.

The first detection terminal 32C is electrically connected to the first data communication terminal 32A by means of a Zener diode.

When the aerosol generating device 2 is properly housed or received in the recess 102 of the portable charging device 100:
the first and second communication terminals 32A, 116A are electrically connected to provide a single data communication link between the first and second MCUs 38, 126,
the first and second charging terminals 32B, 116B are electrically connected to provide a charging link that allows the first energy storage device 14 to be charged by the second energy storage device 106 through the DC/DC converter 122, or by the external power source through the second charging circuit 118 and the switching circuit 124—it being understood that the voltage output terminal of the DC/DC converter 122 and the output terminal of the switching circuit 124 are electrically connected in parallel to the second charging terminal 116B, and that the first charging terminal 32B is electrically connected to the input terminal of the first charging circuit 34,
the first and second detection terminals 32C, 116C are electrically connected to provide a detection link, thereby allowing the first and second MCUs 38, 126 to detect the electrical connection between the aerosol generating device 2 and the portable charging device 100, and
the first and second ground terminals 32D, 116D are electrically connected to form a common power ground connection labelled “PGND”. The negative terminal of the second energy storage device 106 is electrically connected to the common power ground connection.

Data can be transmitted from the fifth input/output terminal of the second MCU 126 to the fifth input/output terminal of the first MCU 38 through the first and second data communication terminals 32A, 116A—i.e., through the single data communication link. Such data transmission will involve the first and third semiconductor switches T1, T3.

More particularly, when the fifth input/output terminal of the second MCU 126 does not output a high level signal, the first semiconductor switch T1 is kept in an open state. When the first semiconductor switch T1 is open, the emitter terminal of the first semiconductor switch T1 and the second data communication terminal 116A are electrically isolated from the output terminal of the second LDO regulator 120. Consequently, the emitter terminal of the first semiconductor switch T1 and the second data communication terminal 116A have substantially the same electrical potential as the ground connection by means of the first and second resistors. In other words, a low level signal is supplied to the second data communication terminal 116A. A low level signal is also supplied to the base terminal of the third semiconductor switch T3 through the first and second data communications terminals 32A, 116A. As a result, a low level signal is finally supplied to the fifth input/output terminal of the first MCU 38.

When the fifth input/output terminal of the second MCU 126 outputs a high level signal, the first semiconductor switch T1 is kept in a closed state. When the first semiconductor switch T1 is closed, the emitter terminal of the first semiconductor switch T1 and the second data communication terminal 116A are electrically connected to the output terminal of the second LDO regulator 120. Consequently, the emitter terminal of the first semiconductor switch T1 and the second data communication terminal 116A have substantially the same electric potential as the output terminal of the second LDO regulator 120. In other words, a high level signal is supplied to the second data communication terminal 116A. A high level signal is also supplied to the base terminal of the third semiconductor switch T3 through the first and second data communication terminals 32A, 116A. As a result, a high level signal is finally supplied to the fifth input/output terminal of the first MCU 38.

In this way, the second MCU 126 may transmit serial data to the first MCU 38 by supplying a high or low level signal to the first semiconductor switch T1.

Data can be transmitted from the sixth input/output terminal of the first MCU 38 to the sixth input/output terminal of the second MCU 126 through the first and second data communication terminals 32A, 116A. Such data transmission will involve the second semiconductor switch T2.

More particularly, when the sixth input/output terminal of the first MCU 38 does not output a high level signal, the base terminal of the second semiconductor switch T2 has substantially the same electrical potential as the ground connection by means of the first resistor. As a result, a low level signal is supplied to the sixth input/output terminal of the second MCU 126.

When the sixth input/output terminal of the first MCU 38 outputs a high level signal, the high level signal is supplied to the base terminal of the second semiconductor switch T2 through the first and second data communication terminals 32A, 116A. As a result, a high level signal is supplied to the sixth input/output terminal of the second MCU 126

In this way, the first MCU 38 may transmit serial data to the second MCU 126.

The second MCU 126 of the portable charging device 100 controls an operation of the portable charging device 100 based on the motion of the aerosol generating device 2 detected by the accelerometer 20. Such motion may include tilting, lifting, shaking, or tapping the aerosol generating device 2, for example. It will be understood that the user may move or tap the assembly that comprises the physically and electrically connected aerosol generating article 2 and portable charging device 100.

The first MCU 38 of the aerosol generating device 2 may convert the motion data received from the accelerometer 20, i.e., from the inertial interrupt terminals of the accelerometer 20, so that the volume of the motion data transmitted to the second MCU 126 is reduced. For example, the motion data provided by the accelerometer 20 to the second and third input/output terminals of the first MCU 38 may be simplified or processed by the first MCU. The first MCU 38 then transmits the converted (i.e., simplified, or processed motion data) to the second MCU 126 through the data communication link provided by the first and second data communication terminals 32A, 116A. This reduces the volume of motion data that needs to be transmitted from the aerosol generating device 2 to the portable charging device 100. The second MCU 126 is configured to determine if the converted motion data meets a predefined criterion—e.g., if it indicates that the assembly has been moved in a particular way-such as lifted, tilted, shaken or tapped. If a predefined criterion is met, the second MCU 126 may carry out a particular operating function. For example, the second MCU 126 may be configured to determine if the motion data from the first MCU 126 indicates that the assembly has been shaken and then carry out a particular operating function, e.g., notify the charge level of the second energy storage device 106 to the user. Alternatively, the first MCU 38 of the aerosol generating device 2 may be configured to determine if the motion data from the accelerometer 20 meets a predefined criterion, and then convert the motion data into simplified motion data indicating whether the motion data meets the predefined criterion. For example, the first MCU 38 may be configured to determine if the motion data received from the accelerometer 20 indicates that the assembly has been shaken and then transmit to the second MCU 126 simplified motion data (e.g., a high level signal) that indicates that the assembly has been shaken. In this example, a low level signal supplied to the second MCU 126 indicates that the assembly has not been shaken. This reduces the volume of motion data that needs to be transmitted to the portable charging device 100 though the data communication link, and also reduces the processing that needs to be carried out by the second MCU 126.

The second MCU 126 may control the portable charging device 100 according to a user interface system that is selectively configurable by a user. The user interface system is responsive to particular user inputs and allows the portable charging device 100 to control or initiate particular operating functions, including both essential and non-essential operating functions. The user interface system may include hardware and software components. The software components of the user interface system may be implemented in the second MCU 126.

For the purposes of the following description, it is assumed that in this example the user interface system is responsive to the following user inputs that are predefined (“predefined user inputs”) and where each user input corresponds to a particular action that is performed by the user when the aerosol generating device 2 is physically connected to the portable charging device 100:
pressing the second push button 108 for a short period of time (or “short press”),
pressing the second push button 108 for an intermediate period of time (or “intermediate press”),
pressing the second push button 108 for a long period of time (or “long press”),
lifting up the assembly (“move device”), and
shaking the assembly (“shake device”). It will be understood that the user inputs “move device” and “shake device” may only be used when the aerosol generating device 2 is physically and electrically connected to the portable charging device 100. The user interface system may therefore be selectively configurable by the user differently for different operating modes, e.g., when the aerosol generating device 2 is connected and when it is not connected.

It is also assumed that in this example the user interface system may initiate or trigger the following predefined essential and non-essential operating functions:
check the charge level of the second energy storage device 106 of the portable charging device 100 (or “check battery level”),
monitor the charging process (or “monitor charging process”), and
reboot the portable charging device 100 (or “reboot device”).

The push button controller 110 is used to reboot the portable charging device 100. Once low level signals are supplied to both of the first and second push button input terminals for a long period of time, the push button controller 110 outputs a low level signal from the reset terminal. The low level signal is supplied to the enable terminal of the second LDO regulator 120. In response to the low level signal from the push button controller 110, the second LDO regulator 120 will stop providing a regulated voltage supply from the output terminal. This interrupts power to the power supply terminal of the second MCU 126 and so the second MCU 126 will shut down.

The push button controller 110 is configured to output the low level signal from the reset terminal for a predetermined period of time. In other words, after the predetermined period of time has elapsed, the electrical potential of the enable terminal of the second LDO regulator 120 will recover to a high level due to the output voltage from the system terminal of the second charging circuit 118. The second MCU 126 is rebooted when the regulated voltage supply is resumed—i.e., when the power supply terminal of the MCU 126 starts to receive a regulated voltage supply from the second LDO regulator 120.

The low level signal supplied from the reset terminal of the push button controller 110 therefore functions as a reset or reboot signal.

Since the second push button input terminal of the push button controller 110 is electrically connected to ground, the push button controller 110 outputs the reset signal once the user inputs “long press”−i.e., when the user presses the second push button 108 for a long period of time. The second push button 108 may also be used for user inputs “short press” and “intermediate press”—i.e., the second MCU 126 may detect when the user presses the second push button 108 for a short period of time or an intermediate period of time.

The accelerometer 20 of the aerosol generating device 2 is used to detect the user inputs “move device” and “shake device”. In particular, the second MCU 126 receives motion data through the data communication link provided by the first and second data communication terminals 32A, 116A that may be used to determine if the user has lifted the assembly or shaken it in a way that corresponds to a predefined user input.

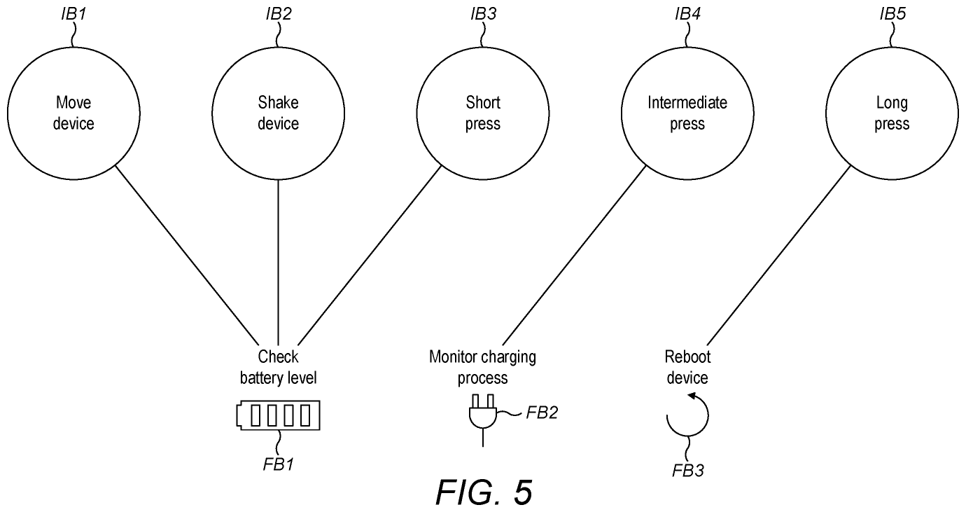

An example of a user interface system is shown in FIG. 5 where the user inputs and the operating functions are represented graphically. In particular, the user may selectively configure the user interface system using a software application such as a mobile application (or “mobile app”) running on a smartphone 200. The smartphone 200 communicates wirelessly with the portable charging device 100 so that any changes made using the software application are updated to the user interface system operating on the smartphone. The smartphone 200 may communicate with the portable charging device 100 using the antenna 128 with any suitable communication protocol (e.g., Bluetooth) or over a wireless network.

Each user input is represented graphically in FIG. 5 by an input button IB1, 1B2, . . . , and IB5. The input buttons IB1, IB2, . . . , and IB5 are displayed to the user on the touchscreen 202 of the smartphone 200.

Each operating function is represented graphically by a function button FB1, FB2 and FB3. The function buttons FB1, FB2 and FB3 are displayed to the user on the touchscreen 202 of the smartphone 200 and are positioned in a row underneath the row of input buttons IB1, IB2, . . . , and IB5.

The user interface system may be selectively configured by the user using the touchscreen 202 of the smartphone 200. More particularly, the user interface system may be selectively configured by the user by touching or tapping any of the buttons, or by other direct manipulation of the graphical representations such as touching, holding and dragging, or swiping, for example.

Using the smartphone 200, the user may disable one or more of the predefined user inputs by touching the appropriate input button for a long period of time. The user may also disable one or more of the predefined non-essential operating functions by touching the appropriate function button for a long period of time. The button for a disabled user input or operating function may be greyed out on the touchscreen 202 to indicate that this particular user input or operating function has been disabled. Essential operating functions may not be disabled even if the corresponding function button is touched for a long period of time. Touching a greyed out button for a long period of time will enable the corresponding user input or operating function.

The user may assign one or more of the enabled user inputs to each of the enabled operating functions. A relationship or assignment between a particular user input and a particular operating function may be created by touching the appropriate input button for a short period of time and then touching the appropriate function button for a short period of time or vice versa, or by touching the touchscreen 202 somewhere generally between the appropriate input button and the appropriate function button, for example. If a user input or non-essential operating function is disabled, any existing relationships with that user input or operating function may be deleted or may be reassigned by the user interface system—e.g., to a default relationship. If an enabled user input is not assigned to a particular operating function, the user may be asked to either provide an assignment or to disable the user input. Similarly, if an enabled non-essential operating function does not have a user input assigned to it, the user may be asked to either provide an assignment or to disable the non-essential operating function. If an essential operating function does not have a user input assigned to it, the user may be asked to provide an assignment to ensure proper operation of the aerosol generating device, or the user interface system may provide a default relationship with one or more of the enabled user inputs.

Referring to FIG. 5, the user inputs “Move device”, “Sshake device” and “Short press” have been assigned to the operating function “Check battery level” so that if the user presses the second push button 108 for a short period of time, or lifts or shakes the assembly, the portable charging device 100 will be controlled to notify the user of the remaining charge level of the second energy storage device 106. This might be done by the second MCU 126 controlling the second LED driver 114, for example. The user input “Intermediate press” has been assigned to the operating function “Monitor charging process” and the user input “Long press” has been assigned to the operating function “Reboot device”. The relationships or assignments between the user inputs and the operating functions are represented graphically by straight lines linking the respective buttons, and more particularly by:
the straight lines linking the input buttons IB1, IB2 and IB3 to the function button FB1,
the straight line linking the input button IB4 to the function button FB2, and
the straight line linking the input button IB5 to the function button FB3.

An existing relationship may be removed by touching the appropriate input button for a short period of time and then touching the appropriate function button for a short period of time, or vice versa, or by touching the straight line that links the respective buttons. For example, the relationship between the user input “Move device” and the operating function “Check battery level” might be removed by touching the straight line linking the respective buttons IB1 and FB1, and the user input “Move device” may then be assigned to a different operating function. Alternatively, an existing relationship might be reassigned by the user by touching the appropriate straight line, holding it and dragging it, for example.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. An assembly comprising:
an aerosol generating device that is physically connected with a portable charging device, the aerosol generating device comprising a motion sensor for detecting motion of the aerosol generating device; and
the portable charging device, the portable charging device comprising first controller and a second controller, the second controller being electrically connected to the motion sensor,
wherein the first controller is configured to control an operation of the portable charging device based on the motion of the aerosol generating device detected by the motion sensor; and
wherein the second controller configured to:
disable the motion sensor when the aerosol generating device enters a sleeping mode;
detect an electrical connection between the portable charging device and the aerosol generating device; and
enable the motion sensor when the electrical connection between the portable charging device and the aerosol generating device is detected.

2. An assembly according to claim 1, wherein the motion sensor is an accelerometer.

3. An assembly according to claim 1, wherein the second controller is electrically connected to the first controller when the aerosol generating device is physically connected with the portable charging device, and wherein the second controller is configured to transmit motion data to the first controller.

4. An assembly according to claim 3, wherein the second controller is further configured to:
convert the motion data so that volume of the motion data is reduced; and
transmit the converted motion data to the first controller.

5. An assembly according to claim 4, wherein the second controller is further configured to:
determine if the motion data meets a predefined criterion; and
convert the motion data into a simplified motion data indicating whether the motion data meets the predefined criterion.

6. An assembly according to claim 4, wherein the converted motion data is transmitted by a single electrical wire from the second controller to the first controller.

7. An assembly according to claim 1, wherein the second controller is further configured to control an operation of the aerosol generating device based on the motion of the aerosol generating device detected by the motion sensor.

8. An assembly according to claim 7, wherein;
the aerosol generating device is housed in the portable charging device;
the first controller is further configured to control an operation of the portable charging device based on the motion of the aerosol generating device detected by the motion sensor except for tapping; and
the second controller is further configured to control an operation of the aerosol generating device based on the user tapping the aerosol generating device detected by the motion sensor.

9. An assembly according to claim 1, wherein the portable charging device further comprises a selectively-configurable user interface system comprising a plurality of predefined user inputs, and at least one predefined essential operating function of the portable charging device, wherein at least one of the predefined user inputs is based on the motion of the aerosol generating device detected by the motion sensor.

10. An assembly according to claim 9, wherein the user interface system is selectively configurable by a user to:
disable and enable at least one of the user inputs; and
assign one or more of the enabled user inputs to each essential operating function of the portable charging device.

11. An assembly according to claim 9, wherein the user interface system further comprises, and wherein the user interface system is further selectively configurable by the user to:
disable and enable at least one of the non-essential operating functions; and
assign one or more of the enabled user inputs to each enabled non-essential operating function of the portable charging device.

12. An assembly according to claim 1, wherein the portable charging device further comprises:
an output device, wherein the first controller is configured to control an operation of the output device based on the motion of the aerosol generating device detected by the motion sensor.

13. A software application for selectively configuring the user interface system of the assembly according claim 9.

14. An assembly comprising:
an aerosol generating device that is physically connected with a portable charging device, the aerosol generating device comprising a motion sensor for detecting motion of the aerosol generating device; and
the portable charging device, the portable charging device comprising first controller and a second controller, the second controller being electrically connected to the motion sensor
wherein the first controller is configured to control an operation of the portable charging device based on the motion of the aerosol generating device detected by the motion sensor;
wherein the second controller is configured to control an operation of the aerosol generating device based on the motion of the aerosol generating device detected by the motion sensor, and
wherein:
the aerosol generating device is housed in the portable charging device;
the first controller is further configured to control an operation of the portable charging device based on the motion of the aerosol generating device detected by the motion sensor except for tapping; and
the second controller is further configured to control an operation of the aerosol generating device based on the user tapping the aerosol generating device detected by the motion sensor.

15. A method of controlling an assembly comprising a portable charging device, and an aerosol generating device that is physically connected with the portable charging device, the aerosol generating device comprising a motion sensor, the method comprising:
controlling an operation of the portable charging device based on motion of the aerosol generating device detected by the motion sensor;
disabling the motion sensor when the aerosol generating device enters a sleeping mode;
detecting an electrical connection between the portable charging device and the aerosol generating device; and
enabling the motion sensor when the electrical connection between the portable charging device and the aerosol generating device is detected.

16. The method of controlling the assembly of claim 15 further comprising:
controlling an operation of the aerosol generating device based on the user tapping the aerosol generating device detected by the motion sensor.
